(19) United States
(12) Patent Application Publication
(10) Pub. No.: US 2019/0116793 A1
(43) Pub. Date: Apr. 25, 2019

(54) FUNGICIDAL FORMULATION

(71) Applicant: PBI-Gordon Corporation, Kansas City, MO (US)

(72) Inventors: Dale Sanson, Kearney, MO (US); Jeff Marvin, Overland Park, KS (US); Brian Aynardi, Bellefonte, PA (US); Alan Estes, Pendleton, SC (US)

(21) Appl. No.: 16/154,423

(22) Filed: Oct. 8, 2018

Related U.S. Application Data
(60) Provisional application No. 62/576,954, filed on Oct. 25, 2017.
(60) Provisional application No. 62/649,415, filed on Mar. 28, 2018.

(51) Int. Cl. A01N 43/653; A01N 43/10

(52) U.S. Cl. CPC A01N 43/653; A01N 25/02; A01N 43/10

(57) ABSTRACT

Liquid fungicidal compositions and methods for reducing phytotoxic effects of repeated exposure of vegetation to a demethylation inhibitor (DMI) fungicide are provided. The fungicidal composition comprises a mixture of at least one DMI fungicide and at least one succinate dehydrogenase inhibiting (SDHI) fungicide. Methods include applying the fungicidal composition on and/or near vegetation having or susceptible to a fungal infestation.

### CROSS-REFERENCE TO RELATED APPLICATIONS

The present application claims the benefit of U.S. Provisional Patent Application No. 62/576,954, filed Oct. 25, 2017, and U.S. Provisional Patent Application No. 62/649,415, filed Mar. 28, 2018, each of which is incorporated by reference herein in its entirety.

### BACKGROUND OF THE INVENTION

### Field of the Invention

The present invention is generally directed toward a liquid fungicidal formulation that comprises a mixture of at least one demethylation inhibitor (DMI) fungicide and at least one succinate dehydrogenase inhibiting (SDHI) fungicide. The liquid fungicidal formulation is suited for use in reducing the incidence of fungal infestation in a few varieties of vegetation, especially turfgrasses, without causing the plants to exhibit adverse phytotoxic effects as can be observed with solely DMI fungicide applications.

### Description of the Prior Art

Demethylation inhibitors are a subclass of sterol biosynthesis inhibitor fungicides first introduced to the market in the 1970s and early 1980s used widely throughout the turfgrass industry for their broad-spectrum control of a variety of fungal pathogens which may be detrimental to the growth of high amenity turfgrass. There are numerous DMI fungicides registered for use in the turfgrass industry currently, including tebuconazole, propiconazole, metconazole, fenarimol, triticonazole, triadimefon, and myclobutanil. Although the use DMI fungicides is widespread throughout the world, leading turfgrass research experts and golf course superintendents alike have documented the adverse non-target effects of these fungicides on greens-height creeping bentgrass and annual bluegrass, particularly during the summer months when environmental stresses are extreme. Non-target effects may be defined as the abnormal or unwanted negative impacts to the turfgrass canopy. Non-target effects on creeping bentgrass from fungicides include phytotoxicity, discoloration, plant growth regulation, and increased infestations of algae. DMI fungicides often result in canopy thinning (or loss of turfgrass density) under hot conditions in the summer.

The first succinate dehydrogenase inhibiting (SDHI) fungicide, flutalonil, was brought to market in the 1980s. However, since the early 2000s, there have been many SDHI fungicides available in the turfgrass market for disease control. While some of the SDHI fungicides have broad-spectrum control, the majority are more specialized products controlling only a few key economically important diseases. Unlike, DMI's, the SDHI fungicides do not result in loss of turfgrass quality, nor do they possess any negative effects on the growth of low-mowed turfgrass.

### SUMMARY OF THE INVENTION

According to one embodiment of the present invention, there is provided a liquid fungicidal composition comprising at least one demethylation inhibitor (DMI) fungicide and at least one succinate dehydrogenase inhibiting (SDHI) fungicide.

According to another embodiment of the present invention, there is provided a method of reducing the incidence of fungal infestations in vegetation. The method comprises the step of applying, in the locus of the vegetation, a liquid fungicidal composition comprising at least one DMI fungicide and at least one SDHI fungicide.

According to yet another embodiment of the present invention, there is provided a method of reducing the phytotoxic effects of DMI fungicide applications on vegetation. The method comprises the step of applying, in the locus of the vegetation, a fungicidal composition comprising at least one DMI fungicide and at least one SDHI fungicide.

According to still another embodiment of the present invention, there is provided a method treating vegetation with a liquid fungicidal formulation comprising the step of applying, in the locus of the vegetation, the liquid fungicidal formulation. The liquid fungicidal formulation comprises at least one DMI fungicide and at least one SDHI fungicide.

### DETAILED DESCRIPTION OF THE PREFERRED EMBODIMENT

Embodiments of the present invention pertain to fungicidal compositions, especially liquid fungicidal formulations, that comprise a mixture of at least one demethylation inhibitor (DMI) fungicide and at least one succinate dehydrogenase inhibiting (SDHI) fungicide. It is an aim of certain embodiments of the present invention to provide a fungicidal composition that offsets potentially negative effects associated with one type of fungicide, particularly the DMI fungicide, by mixing it with another fungicide, particularly the SDHI fungicide. Thus, the resulting composition exhibits the beneficial fungicidal characteristics of the fungicide compounds but does so without negative effects often observed with one or both types of fungicides. Therefore, certain embodiments of the present invention result in reduced phytotoxic effects as compared with the use of an individual fungicide, improved vegetation quality as compared with repeated use of an individual fungicide exemplified by reduced thinning of vegetation especially in terms of reduced thickness of turfgrass canopy, and reduce fungal infestations and populations of algae in turfgrass canopies compared to repeated applications of individual fungicides. In particular embodiments, the fungicidal compositions according to the present invention provide for a much safer chemistry in terms of maintaining overall plant health while still providing adequate, and in some cases better, control over fungal infestations.

Preferred DMI fungicides that may be used with the present invention include various triazole, imidazole, piperazine, pyridine, and pyrimidine compounds. Exemplary triazole compounds include azaconazole, bitertanol, bromuconazole, cyproconazole, difenoconazole, diniconazole, epoxiconazole, fenarimol, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, and triticonazole. Exemplary fungicidal imidazole compounds include imazalil, oxpoconazole, pefurazoate, prochloraz, and triflumizole. An exemplary fungicidal piperazine compound is triforine. An exemplary fungicidal pyridine compound is pyrifenox. Exemplary fungicidal pyrimidine compounds include fenarimol and nuarimol. Tebuconazole is a particularly preferred DMI fungicide for use with the present invention.

Preferred SDHI fungicides that may be used with the present invention include various phenyl-benzamide, phenyl-oxo-ethyl thiophene amide, pyridinyl-ethyl-benzamide, furan-carboxamides, oxathiin-carboxamide, thiazole-carboxamides, pyrazole-carboxamides, and pyridine-carboxamide compounds. Exemplary phenyl-benzamide compounds include benodanil, flutolanil, and mepronil. An exemplary phenyl-oxo-ethyl thiophene amide compound is isofetamid. An exemplary pyridinyl-ethyl-benzamide compound is fluopyram. An exemplary furan-carboxamide compound is fenfuram. Exemplary oxathiin-carboxamide compounds include carboxin and oxycarboxin. An exemplary thiazole-carboxamide compound is thifluzamide. Exemplary pyrazole-carboxamide compounds include benzovindiflupyr, bixafen, fluxapyroxad, furametpyr, isopyrazam, penflufen, penthiopyrad, and sedaxane. An exemplary pyridine-carboxamide compound is boscalid. Isofetamid is a particularly preferred SDHI fungicide for use with the present invention. Among them, the combination of tebuconazole and isofetamid is preferable combination.

In certain embodiments of the present invention, the at least one DMI fungicide and the at least one SDHI fungicide are mixed so as to provide a relative weight ratio of the DMI fungicide to the SDHI fungicide of from about 0.5:1 to about 12:1, from about 0.5:1 to about 10:1, from about 1:1 to about 6:1, or from about 1:1 to about 4:1, or from about 2:1 to about 4:1.

In particular embodiments, each DMI fungicide and SDHI fungicide may be formulated separately, and these formulations may be mixed so as to provide the fungicidal composition and/or the fungicidal formulation. Commercial standalone products of DMI or SDHI fungicidal formulations are also available. For example, TORQUE or TebuStar 3.6F for tebuconazole, BANNER MAXX for propiconazole, KABUTO for isofetamid, VELISTA for penthiopyrad, XZEMPLAR for penthiopyrad, BAYLETON FLO for triadimefon etc.

In particular embodiments, the fungicidal formulation is formulated as a liquid premixed formulation that can be diluted with water and/or other commonly used mixing agents/components immediately prior to application. In such applications, the liquid premixed formulation is diluted with water at a volume ratio of about 1:20 to about 1:120, or about 1:35 to about 1:100, or about 1:50 to about 1:75 to provide the fungicidal composition.

In other embodiments, the premixed fungicidal formulation can also be prepared in granular form. In preferred embodiments, the granule is a water dispersible granule (WDG) that may be mixed with water to provide the fungicidal composition and applied to the target vegetation as a spray. In certain embodiments, WDGs according to the present invention are prepared by forming a mixture of the DMI and SDHI fungicides, one or more dispersants, wetting agents, fillers, and other additives such as surfactants and urea. These components are combined in desired ratios and sufficient water is added to prepare a dough-like substance that is introduced into an extruding unit. The extruded product is processed to achieve uniform sizing and then dried to remove water. Exemplary WDG compositions are described further in Table 2, below.

Other granule compositions can be prepared by applying and drying a liquid mixture of the DMI and SDHI fungicides onto a granule carrier. The granule carrier may be any granule suitable for use in the industry including fertilizer granules or inert granules, such as high load capacity clay carriers of montmorillonite or attapulgite compositions produced by the Oil Dri Corporation (Chicago, Ill.), other clays, AGSORB (a mineral-based product from Agsorb Products Group, Chicago, Ill.), and dolomitic limestone pellets (sold under the name brands DGLite® DGPro® L150, DH46 and DH66 by The Andersons, Maumee, Ohio). Bio-derived carriers may also be used such as corn grits, corn cob, and peanut and/or rice hulls.

Fungicidal formulations according to the present invention may optionally include various inert components such as surfactants, suspending agents, freezing point depressants, thickeners, deionized water, preservative, pH adjusting agents, and antifoaming agents. In certain embodiments, one or more nonionic surfactants may be present, such as a polymethyl methacrylate-polyethylene glycol graft copolymer, specifically ATLOX 4913 available from Croda Crop Care. ATLAS G5000, also available from Croda Crop Care, is a polyalkylene oxide block copolymer having a high HLB value and is useful as a suspending agent, dispersant, or emulsifier. Other preferred inert components include an antifreeze agent and/or a gelling or thickening agent. In preferred embodiments, the antifreeze agent is a branched or linear glycol selected from the group consisting of propylene glycol, hexylene glycol, glycerin, and mixtures thereof. The thickening agent may comprise xanthan gum (e.g., KELZAN, available from CP Kelco). Citric acid is a preferred pH adjusting agent, as it is desirable for the pH of a certain embodiment of the present invention to be adjusted to within the range of 6.2 to 7.0.

Table 1, below, describes exemplary fungicidal formulations according to the present invention. The described formulations are formulated as premixes intended for dilution prior to application at the aforementioned dilution ratios.

TABLE 1

| | Broad range | Intermediate range | Narrow range |
|---|---|---|---|
| Component | (wt. %) | (wt. %) | (wt. %) |
| SDHI fungicide | 0.1-15 | 0.5-10 | 1-7.5 |
| DMI fungicide | 0.5-25 | 5-20 | 7.5-16 |
| Nonionic surfactant | 0.1-3 | 0.5-2.5 | 1-2 |
| (e.g., Atlox 4913) | | | |
| Suspending | 0.1-3 | 0.5-2.5 | 1-2 |
| agent/emulsifier | | | |
| (e.g., Atlas G5000) | | | |
| Antifreeze agent | 1-10 | 2-8 | 4-6 |
| (e.g., propylene | | | |
| glycol) | | | |
| Thickener (Kelzan) | 0.01-1.5 | 0.05-1 | 0.1-0.5 |
| DI Water, | QS | QS | QS |
| Preservative, citric | | | |
| acid, antifoam | | | |

Various water dispersible granule compositions comprising the DMI and SDHI fungicides made in accordance with the present invention are described in Table 2. The various components are combined in the prescribed amounts and sufficient water is added thereto to prepare a dough that is extruded into particles of a desired size. The particles may need to be processed further, such as through sieving, in order to achieve uniform sizing. Once uniform sizing is achieved, the particles are dried to produce a commercial pesticide product.

TABLE 2

| Ingredient | Wt % | Examples | Function |
|---|---|---|---|
| Active ingredients | 10-75% | Tebuconazole and | DMI and SDHI |
| | | Isofetamid | Fungicide |
| | | | Combination |
| Dispersant | 2-6% | Modified styrene | Assists in |
| | | acrylic polymer, | maintaining the |
| | | sodium lignosulfate | suspending |
| | | | properties of the |
| | | | formulation and |
| | | | prevent |
| | | | agglomeration in the |
| | | | aqueous spray tank |
| | | | environment. |
| Wetting Agent | 2-6% | Dioctyl sodium | Facilitates the |
| | | sulfosuccinate, | disintegration of the |
| | | naphthalene | formulation upon |
| | | sulfonate | introduction to |
| | | | water. |
| Inert Filler | 20-80% | Bentonite, Kaolin or | Inert filler adding |
| | | Fuller's Earth Clays | bulk to the |
| | | | formulation to assist |
| | | | in more accurate |
| | | | measurement of the |
| | | | formulation |
| Other Ingredients | 2-5% | Nonionic and | Increased adjuvancy |
| | | anionic surfactants, | and efficacy of the |
| | | urea | active ingredients. |

The fungicidal compositions described herein may be applied to vegetation to control, prevent, reduce the instances of, and/or eliminate fungal infestations within the vegetation. It is noted that the term “prevent” encompasses the use of the fungicidal compositions in a prophylactic manner, namely the fungicidal composition is applied to the vegetation before a fungal infestation is observable thereby preventing and/or inhibiting the development of an observable fungal infestation. These methods may comprise applying the liquid fungicidal composition in the locus of the vegetation. As noted above, the fungicidal formulations may be initially provided as a premixed or concentrated fungicidal formulation that is diluted prior to application to the vegetation. Dilution may occur, for example, in a mixing tank. Application of the fungicidal composition prepared by the diluted formulation to the vegetation may be carried out by any customary means in the art, such as by spraying directly onto and/or in the general vicinity of the vegetation to be treated.

The fungicidal compositions described herein may be used in performing other methods as well. In one embodiment, the fungicidal compositions are used to reduce the phytotoxic effects of single and repeated DMI fungicide applications on vegetation. As noted previously, repeated DMI fungicide applications can place stress on the vegetation, thereby reducing the health and vigor thereof. By repeatedly applying an admixture of at least one DMI fungicide and at least one SDHI fungicide, it has been discovered that these harmful effects can be mitigated and plant health and vigor maintained at a significantly higher level. However, a reduction in phytotoxic effects and improved turf quality following even an initial or single application of a DMI fungicide due to plant shock have been observed with the present invention. The reduction in phytotoxic effects has been demonstrated especially in turfgrasses, and in particular, in grasses used as golf course greens maintained at a height of cut of approximately 0.1 to approximately 0.2 inch.

In certain embodiments, what is meant by “repeated applications of” or “repeatedly applying” the fungicidal composition are sequential applications of the fungicidal composition occurring at least 1 day, at least 5 days or at least 7 days apart. In other embodiments, the sequential applications are spaced from about 7 days to about 28 days apart.

The fungicide may be applied to the locus of target vegetation in sufficient quantity so as to deliver from about 0.02 to about 5.0 lb/acre, about 0.15 to about 4.0 lb/acre, or about 0.3 to about 3.4 lb/acre of the fungicidal compounds present therein. In particular embodiments, the fungicide is applied so as to deliver from 0.01 to about 1.5 lb/acre, from about 0.05 to about 1.0 lb/acre, or from about 0.1 to about 0.7 lb/acre of the one or more SDHI fungicides, and to deliver from about 0.01 to about 3.5 lb/acre, 0.1 to about 3 lb/acre, or from about 0.2 to about 2.7 lb/acre of the one or more DMI fungicides.

In particular, when the SDHI fungicide is isofetamid, the fungicide is applied so as to deliver from about 0.01 to about 1.0 lb/acre, from about 0.2 to about 0.7 lb/acre, from about 0.05 to about 0.54 lb/acre, or from about 0.1 to about 0.4 lb/acre of the isofetamid. When the DMI fungicide is tebuconazole, the fungicide is applied so as to deliver from about 0.01 to about 1.5 lb/acre, from about 0.25 to about 1.5 lb/acre, from about 0.25 to about 1.35 lb/acre, or from about 0.5 to about 1.2 lb/acre of the tebuconazole.

Methods according to the present invention can be used in fungicidal applications on a variety of vegetation, including, but not limited to, turfgrass, rice, wheat, soybeans, other vegetables. Various fungal infestations that may be treated with the fungicidal formulations according to embodiments of the present invention include Dollar Spot (Sclerotinia homoeocarpa); Copper Spot (Gloeocercospora sorghi); Powdery Mildew (Blumeria graminis (Erysiphe graminis)); Rusts (Puccinia spp.); Red Thread (Laetisaria fuciformis); Pink Patch (Limonomyces roseipellis); Brown Ring Patch, Waitea Patch (Waitea circinata var. circinata); Brown Patch, Large Patch, Zoysia Patch (Rhizoctonia solani); Anthracnose, Basal and Foliar (Colletotrichum cereale); Bermudagrass decline, Take-all Root Rot (Gaeumannomyces graminis var. graminis); Take-All Patch (Gaeumannomyces graminis var avenae); Gray Leaf Spot (Magnaporthe oryzae); Stripe Smut (Ustilago striiformis); Spring Dead Spot (Ophiosphaerella korrae, O. herpotricha, O. narmari); Necrotic Ring Spot (Ophiosphaerella korrae); Fusarium Patch (Fusarium roseum); Summer Patch (Magnaporthe poae); Gray Snow Mold, Typhula Blight (Typhula spp.); Pink snow mold, Microdochium Patch (Microdochium nivale); Fairy Ring (Basidiomycete fungi); and Cool Season Brown Patch, Yellow Patch (Rhizoctonia cerealis).

### EXAMPLES

Table 3, below, describes exemplary fungicidal formulations prepared in accordance with the present invention. It is to be understood, however, that these examples are provided by way of illustration and nothing therein should be taken as a limitation upon the overall scope of the invention.

TABLE 3
Exemplary Formulations of DMI and SDHI Fungicides

| | Formulation 1 | Formulation 2 |
|---|---|---|
| Component | (wt. %) | (wt. %) |
| Isofetamid | 5.06 | 6.10 |
| Tebuconazole | 15.18 | 15.18 |
| ATLOX 4913 | 1.50 | 1.50 |
| ATLAS G5000 | 1.50 | 1.50 |
| Propylene Glycol | 5.00 | 5.00 |
| Harcros 8810 IND | 0.02 | 0.02 |
| (antifoam agent, Harcros | | |
| Chemicals Inc.) | | |
| KELZAN (thickener) | 0.20 | 0.20 |
| ACTICIDE B20 (micro- | 0.30 | 0.30 |
| biocide, Thor GmbH) | | |
| Citric Acid (10% solution) | 0.14 | 0.14 |
| Deionized water | QS | QS |

### Example 1

In this example, several fungicidal formulations were tested for impact on dollar spot development on creeping bentgrass. The first product tested was KABUTO Fungicide SC, comprising 36.0% isofetamid, available from PBI-Gordon Corporation. The second product tested was TORQUE fungicide, from Nufarm, comprising 38.7% tebuconazole. Both KABUTO and TORQUE were standalone products tested as received from their respective manufacturer. The third formulation tested was Formulation 1 from Table 3, above, which comprised a premix of isofetamid and tebuconazole that was diluted in the sprayer tank immediately prior to application. All treatments were commenced on Day 1 and reapplied according to the indicated application schedule. The results of this testing are provided in Table 4.

TABLE 4
Impact of Fungicides on Dollar Spot Development on Creeping Bentgrass

| | Product rate/ | Application | Turf quality^{1,2} | | Color^{1,3} | | Phytotoxicity^{1,4} | |
|---|---|---|---|---|---|---|---|---|
| Chemical | 1000 ft² | schedule | Day 57 | Day 85 | Day 57 | Day 85 | Day 18 | Day 25 |
| KABUTO | 0.5 fl oz | 14 day | 6.2 | 5.7 | 5.3 | 5.0 | 1.0 c | 1.0 b |
| TORQUE | 1.1 fl oz | 21 day | 5.8 | 3.9 | 5.1 | 5.5 | 1.0 c | 1.0 b |
| Formulation 1 | 3.0 fl oz | 21 day | 5.8 | 7.7 | 5.2 | 5.0 | 1.0 c | 1.0 b |

¹Values are means of four replicates. Means followed by the same letter are not significantly different according to Waller-Duncan k-ratio t-test (k = 100).
²Turf quality on a scale of 1 to 9, where 9 = best turf quality and 5 = commercially acceptable quality.
³Color of foliage on a 1-10 scale, where 5 = color of healthy untreated turf, less than 5 = progressively more chlorotic/necrotic turf, and greater than 5 = progressively darker green turf.
⁴Phytotoxicity on a 1 to 5 scale, where 1 = no discoloration, 2 = slight foliar chlorosis or necrosis, 3 = moderate chlorosis or necrosis, 4 = severe chlorosis or necrosis, and 5 = all turf dead.

Formulation 1 showed similar turf quality to KABUTO and TORQUE 57 days in. However, turf quality for Formulation 1 was superior to KABUTO and TORQUE at Day 85.

### Example 2

In this example, the effects of various DMI and SDHI fungicides and combinations thereof on bentgrass summer stress were tested. All materials were tested on a 14-day application schedule. Both TORQUE and BANNER MAXX (Syngenta) are DMI fungicides. KABUTO, VELISTA (Syngenta), and XZEMPLAR (BASF) are SDHI fungicides. All standalone products were tested as received from their respective manufacturer. The binary formulations were formulated as a premix so as to provide active ingredient application rates that were the same as the application rates for the tested individual actives. Application rates for each active are provided in Table 5. The light box photo testing comprised digital analysis of images taken of bentgrass samples treated with the indicated compositions. The dimensions of the light box used was 24×24×24 inches. Ratings were taken from the center of each plot. Each plot measured 1×3 meters. The camera height was 24 inches from the turf canopy. The light box was utilized to make sure any digital imagery was devoid of shadows, and each plot was subject to the same light. F-stop and aperture remained constant, allowing all images to have a similar hue spectrum. “Percent Cover” means the percent of pixels representing turf as compared to the total number of pixels in the image. “Average Green” refers to an analysis of the “greenness” of the pixels identified as representing turf grass. The results of all testing are shown in Table 6.

TABLE 5

| | | | | Concentrated Form of AI | | | |
|---|---|---|---|---|---|---|---|
| | Active | Mode of | | Lbs/Gal for SC, or | g/L for SC or | Lbs | kg |
| Trade Name | Ingredient | Action | Formulation | Lbs/Lb for WG | g/Kg for WG | AI/A * | AI/ha * |
| BANNER | propiconazole | DMI | SC | 1.3 | 156 | 0.664 | 0.744 |
| MAXX | | | | | | | |
| TORQUE | tebuconazole | DMI | SC | 3.6 | 431 | 1.35 | 1.51 |
| VELISTA | penthiopyrad | SDHI | WG | 0.5 | 500 | 0.273 | 0.306 |
| XZEMPLAR | fluxapyroxad | SDHI | SC | 2.47 | 296 | 0.132 | 0.148 |
| KABUTO | isofetamid | SDHI | SC | 3.33 | 400 | 0.56 | 0.628 |

* Pounds or kilograms AI per unit area based on a single application.
SC = suspension concentrate;
WG = water dispersible granules

TABLE 6
Effects of Fungicides on Bentgrass Summer Stress

| | | | | | | | | | | | | | | Lightbox Photos | | | |
|---|---|---|---|---|---|---|---|---|---|---|---|---|---|---|---|---|---|
| | Product | | | | | | | | | | | | | (Day 147) | | | |
| | rate/1000 | Turf quality^{1,2} | | | | | | Phytotoxicity^{1,3} | | | | | | | | Avg. | |
| Treatment name | ft² | Day 22 | | Day 57 | | Day 70 | | Day 36 | | Day 42 | | Day 57 | | % Cover | | Green | |
| KABUTO (isofetamid) | 0.5 fl oz | 5.75 | d | 6.5 | a | 6.5 | a | 0 | e | 0 | e | 0 | f | 78.88 | b | 145.21 | a |
| VELISTA (penthiopyrad) | 0.0125 lb | 6 | b | 6.5 | b | 6.25 | c | 0 | e | 0.13 | e | 0 | f | 76.42 | e | 144.61 | a |
| XZEMPLAR (fluxapyroxad) | 0.16 fl oz | 6 | a | 6.38 | d | 6.38 | b | 0 | e | 0 | e | 0 | f | 80.59 | a | 145.48 | a |
| BANNER MAXX (propiconazole) | 1.5 fl oz | 4.63 | e | 3.63 | h | 3.38 | h | 2.25 | a | 2.75 | a | 3 | a | 56.34 | g | 140.03 | g |
| TORQUE (tebuconazole) | 1.1 fl oz | 5.5 | d | 5.5 | g | 4.88 | g | 0 | e | 0 | e | 0.63 | f | 75.82 | f | 142.33 | d |
| Formulation 1 | 3 fl oz | 5.63 | d | 5.88 | e | 5.38 | e | 0 | e | 0.25 | e | 0.63 | f | 77.41 | d | 141.88 | e |
| KABUTO + BANNER MAXX | 2(0.5 + 1.5) | 4.63 | e | 3.75 | h | 3.38 | h | 2 | c | 2.5 | b | 2.63 | d | 50.94 | g | 138.66 | h |
| | fl oz | | | | | | | | | | | | | | | | |
| VELISTA + BANNER MAXX | 0.0125 | 4.5 | e | 3.75 | h | 3.63 | h | 1.88 | d | 2.38 | c | 2.88 | b | 66.16 | g | 138.51 | i |
| | lb + 1.5 | | | | | | | | | | | | | | | | |
| | fl oz | | | | | | | | | | | | | | | | |
| VELISTA + TORQUE | 0.125 lb + | 6 | c | 6.38 | c | 5.75 | d | 0.13 | e | 0.38 | e | 0.38 | f | 72.24 | g | 142.96 | c |
| | 1.1 fl oz | | | | | | | | | | | | | | | | |
| XZEMPLAR + BANNER | 1.65(0.16 + | 4.88 | e | 4 | h | 3.5 | h | 2 | b | 2.13 | d | 2.63 | c | 55.06 | g | 140.61 | f |
| | 1.5) fl oz | | | | | | | | | | | | | | | | |
| XZEMPLAR + TORQUE | 1.26(0.16 + | 5.88 | d | 5.75 | f | 5.25 | f | 0.13 | e | 0.38 | e | 0.88 | e | 78.54 | c | 142.99 | b |
| | 1.1) fl oz | | | | | | | | | | | | | | | | |
| Untreated control | | 5.13 | de | 4.25 | h | 4 | gh | 0 | e | 0 | e | 0 | f | 48.01 | g | 146.21 | a |

¹Values are means of four replicates. Means followed by the same letter are not significantly different according to Waller-Duncan k-ratio t-test (k = 100).
²Turf quality on a scale of 1 to 9, where 9 = best turf quality and 5 = commercially acceptable quality.
³Phytotoxicity on a 1 to 5 scale, where 1 = no discoloration, 2 = slight foliar chlorosis or necrosis, 3 = moderate chlorosis or necrosis, 4 = severe chlorosis or necrosis, and 5 = all turf dead.

As can be seen, the combinations comprising BANNER MAXX with SDHI fungicide exhibited less phytotoxicity than BANNER MAXX alone. In addition, the combinations comprising tebuconazole as an active ingredient with SDHI fungicide exhibited better overall turf quality than tebuconazole as the sole active. The lightbox photo analysis showed that percent cover improved with the formulated products Formulation 1 and XZEMPLAR+TORQUE as compared to TORQUE alone, and that percent greenness was also greater for the combination XZEMPLAR+TORQUE and VELISTA+TORQUE as compared to TORQUE alone. It is noted that a number of data points contained within the lightbox data are inconclusive with respect to demonstrating a safening aspect of the combination relative to the DMI fungicides used alone. This is attributable to collecting lightbox data only once at the end of the growing season (day 147) and not throughout the application cycles. It is believed that by this time, the turfgrass had sufficient time to naturally recover from the adverse effects of repeated DMI fungicide applications. This shortcoming is addressed in the trials of Example 3, below. Also, a number of data points contained within the phytotoxicity data are inconclusive with respect to demonstrating a safening aspect of the combinations relative to the DMI fungicides used alone. It is believed that this is primarily attributable to the rating scale used. Because the evaluator had to select an integer between 0 and 10, it was not feasible to distinguish slight, but noticeable, differences in plant health. This shortcoming is also addressed in the trials of Example 3, below, by adopting a rating scale of 0 to 100.

### Example 3

In this example, the effects of various DMI and SDHI fungicides and combinations thereof on bentgrass summer stress were tested. The fungicides were applied to the turfgrass weekly for a total of six consecutive weeks. The turfgrass was evaluated weekly for quality, cover, phytotoxicity effects, and digital quality, with the first evaluation being made the week applications commenced and the last evaluation being made two weeks after applications ended.

Quality was evaluated visually and scored on a scale of 1 to 9, where 9=best turf quality and 6=minimum commercially acceptable quality. Cover was determined from photos of plots taken by a light box. The images were analyzed using the Turf Analyzer software package. (See, www.turfanalyzer.com.) Phytotoxicity was evaluated visually on a 0-100 scale with 0=no phytotoxic effects visible, 50=41-50% area displaying phytotoxic effects, and 100=91-100% area displaying phytotoxic effects. Digital quality was evaluated using light box photographs and a dark green color index (DGCI) analyzer, with the following settings: Low Sat=10, High Sat=100, Low Brightness=0, High Brightness=100, Low Hue=70, and High Hue=170.

The tested fungicides were isofetamid (KABUTO), tridimefon (BAYLETON FLO), and tebuconazole. The standalone products were tested as received from their respective manufacturer. The binary formulations were formulated as a premix so as to provide active ingredient application rates that were the same as the application rates for the tested individual actives. The application rates are provided in Table 7.

TABLE 7

| Treatment | | Active | Mode of | | Application rate | Lbs/(Gal | Lbs | kg |
|---|---|---|---|---|---|---|---|---|
| No. | Trade Name | Ingredient | Action | Formulation | (fl oz/1000 ft²) | or Lb) | AI/A * | AI/ha * |
| 1 | KABUTO | isofetamid | SDHI | SC | 0.4 | 3.33 | 0.455 | 0.510 |
| 2 | BAYLETON | triadimefon | DMI | SC | 1.04 | 4.15 | 1.47 | 1.65 |
| | FLO | | | | | | | |
| 3 | TebuStar | tebuconazole | DMI | SC | 1.1 | 3.6 | 1.35 | 1.51 |
| | 3.6F | | | | | | | |
| 4 | Formulation | Isofetamid + | SDHI + | SC | 3.0 | 6.93 | 1.825 | 2.02 |
| | 1 | tebuconazole | DMI | | | | | |
| 5 | KABUTO + | Isofetamid + | SDHI + | SC | 1.43 | 7.48 | 1.925 | 2.16 |
| | BAYLETON | triadimefon | DMI | | | | | |
| | FLO | | | | | | | |

WP = wettable powder;
SC = suspension concentrate

The results of all evaluations were converted into a single value represented by the area under the progress curve (AUPC), which is a conventional analytical tool used to provide a quantitative summary of disease intensity over time, particularly when it is difficult to surmise week-to-week changes in the plant's health. The AUPC results for each treatment are given in Table 8.

TABLE 8
Area Under Progress Curve Analysis

| Treatment | | | | | Digital |
|---|---|---|---|---|---|
| No. | Active(s) | Quality | Cover | Phytotoxicity | Quality |
| 1 | isofetamid | 230.56 | 3482.18 | 0.88 | 339.52 |
| 2 | triadimefon | 206.16 | 2430.54 | 119.25 | 136.17 |
| 3 | tebuconazole | 213.42 | 3053.49 | 40.63 | 243.71 |
| 4 | Formula 1 | 225.43 | 3264.37 | 10.75 | 299.13 |
| | (isofetamid + | | | | |
| | tebuconazole) | | | | |
| 5 | triadimefon + | 205.49 | 2482.39 | 115.88 | 144.33 |
| | isofetamid | | | | |

Turning first to the AUPC quality data, a higher score generally indicates better turf quality. The data indicates that treatment 4 showed improved turf quality as compared with tebuconazole alone. The turf quality approached that of the SDHI fungicide individually, thus indicating that the ill effects of repeated applications of DMI fungicides to turfgrass could be lessened through combination of the DMI with an SDHI fungicide.

Next, with respect to cover a higher score generally indicates better maintenance of the surface area of the test plot covered by the turfgrass. Again, treatment 4 showed improved cover as compared with tebuconazole alone. Treatment 5 also showed slight improvement over triadimefon alone. While treatment 4 came the closest to approximating the safety of isofetamid alone, both treatments 4 and 5 evidenced that a safening effect against repeated DMI fungicide applications could be achieved through use of the SDHI fungicide in conjunction therewith.

With respect to phytotoxicity, a lower score means that less phytotoxic effects were observed. Both treatments 4 and 5 showed reduced phytotoxicity as compared with their respective DMI fungicides used individually. Again, treatment 4 most closely approximated the safety of isofetamid alone. However, both treatments evidenced a safening effect when the DMI fungicide was used in conjunction with the SDHI fungicide.

Finally, with respect to digital quality, a higher score indicates that better turfgrass quality was observed. The safening trend continues to be observed as both treatments 4 and 5 rated higher than their individual DMI components.

It is noteworthy that in this trial, a reduction in phytotoxic effects due to “plant shock” associated with the initial fungicide application was observed with the present invention. Plant shock may occur when the plant is subjected to a stress, such as lack of water, cold temperature, or improper planting methods. In this example, the stress is the application of a DMI fungicide to the bentgrass. The data is provided in Table 9.

TABLE 9

| Treat- | | | | Day 1 | Day 5 | Day 14 |
|---|---|---|---|---|---|---|
| ment | Day 1 | Day 5 | Day 14 | Phyto- | Phyto- | Phyto- |
| No. | Quality | Quality | Quality | toxicity | toxicity | toxicity |
| 1 | 6.7 | 7 | 7 | 0 | 0 | 0 |
| 2 | 6.85 | 6 | 6.95 | 0 | 2 | 5 |
| 3 | 6.83 | 5.13 | 6.98 | 0 | 4.7 | 0.5 |
| 4 | 6.73 | 6.88 | 6.98 | 0 | 0 | 0.5 |
| 5 | 6.48 | 6.63 | 6.85 | 0 | 0.2 | 5.5* |

*It is believed that the phytotoxic effects observed on day 14 for Treatment 5 were attributable to the fungicide treatment as turf quality remained strong. The data point appears to be an outlier and the result of other environmental conditions that are external to this study.

As can be seen in Table 9, five days following the initial treatments, Treatments 2 and 3 (triadimefon and tebuconazole, respectively) showed significant phytotoxic effects and reduced turf quality as compared with the initial scores on day 1 of the trials. However, for the combination examples comprising both the DMI and SDHI fungicides (Treatments 4 and 5), the phytotoxic effects were negligible, and the turf quality was slightly improved relative to day 1. By day 14, the plants had largely recovered from the shock of the initial DMI fungicide applications. But, a clear safening effect was observed for the initial fungicide applications and turf quality and health was maintained over this initial period.

In sum, the combination of isofetamid and tebuconazole resulted in the observation of safening effects in all four of the evaluations, and produced results that most closely approximated those of the SDHI fungicide. The combination of isofetamid and triadimefon resulted in the observation of safening effects in three of the four evaluations. The combination of the DMI and SDHI fungicides also demonstrated efficacy in reducing plant shock associated with the early applications of the DMI fungicide. Therefore, from the data that the SDHI fungicide had a safening effect on single and repeated applications of DMI fungicides to turfgrass.

A second trial was performed on bentgrass in a different location following the same treatment protocols described above. The bentgrass was evaluated for quality, phytotoxicity, normalized difference vegetative index (NDVI), clipping fresh weight, and clipping dry weight. Quality and phytotoxicity were evaluated as described above. NDVI is a measure evaluating the amount of near infrared light and the amount of visible light reflected by a plant canopy. Healthy, green tissue reflects mostly infrared and a small portion of visible light. As the plant becomes chlorotic or the tissue is damaged, the amount of visible light reflected increases. The higher the NDVI rating the healthier the plant. The NDVI rating was determined using a FieldScout CM 1000 NDVI Chlorophyll Meter from Spectrum Technologies, Inc., which is a handheld device that provides an instantaneous reading of red (660 nm) and near infrared (840 nm) spectral bands. For the clipping weight evaluations, clippings were collected from each treatment two weeks after the initial application, and four additional times on a two-week interval for the remainder of the trial. The clippings were placed in a brown paper bag. Fresh clipping weights were then taken. The clippings were allowed to dry for 3 days, and then dry clipping weights were taken.

As with the first trial in this example, the results of all evaluations were converted into a single value represented by the area under the progress curve (AUPC). The AUPC results for each treatment are given in Table 10.

TABLE 10
Area Under Progress Curve Analysis

| Treat- | | | | | Clipping | Clipping |
|---|---|---|---|---|---|---|
| ment | | | Phyto- | | fresh | dry |
| No. | Active(s) | Quality | toxicity | NDVI | weight | weight |
| 1 | isofetamid | 349.94 | 0.36 | 51.50 | 377.55 | 154.82 |
| 2 | triadimefon | 307.75 | 75.44 | 49.93 | 476.55 | 186.45 |
| 3 | tebuconazole | 336.54 | 14.36 | 51.23 | 474.53 | 175.64 |
| 4 | Formula 1 | | | | | |
| | (isofetamid + | | | | | |
| | tebuconazole) | 346.65 | 2.29 | 51.37 | 501.18 | 183.95 |
| 5 | triadimefon + | | | | | |
| | isofetamid | 309.4 | 62.31 | 50.12 | 499.09 | 186.84 |

Turning first to the quality data, both treatments 4 and 5 resulted in improved turf quality compared to their respective DMI fungicides alone. Unlike the first trial above, it is noted that a safening effect was observed with treatment 5.

With respect to phytotoxicity, a significant safening effect was observed for both treatments 4 and 5 as compared to the individual fungicides alone.

With respect to NDVI, the spread amongst the various treatments was not great, but slight improvements were observed with treatments 4 and 5 as compared to the individual DMI fungicide treatments.

With respect to the clipping weight evaluations, generally a higher score represented heavier clippings, which indicated better plant health and/or better plant ground coverage. Clipping weights improved for treatments 4 and 5 relative to the individual DMI fungicides. Surprisingly, clipping weight was significantly higher for treatments 4 and 5 relative to the individual isofetamid treatment, as DMI fungicides are known as having plant growth regulating (PGR) effects.

In sum, a clear safening effect was observed for the fungicidal treatments comprising both the DMI and SDHI fungicide as turf quality improved and phytotoxicity reduced as compared to the DMI applications alone.

We claim:

1. A liquid fungicidal composition comprising at least one demethylation inhibitor (DMI) fungicide and at least one succinate dehydrogenase inhibiting (SDHI) fungicide.

2. The liquid fungicidal composition of claim 1, wherein the at least one DMI fungicide comprises a triazole compound.

3. The liquid fungicidal composition of claim 2, wherein the triazole compound is tebuconazole.

4. The liquid fungicidal composition of claim 1, wherein the at least one SDHI fungicide comprises a phenyl-oxo-ethyl thiophene amide compound.

5. The liquid fungicidal composition of claim 4, wherein the phenyl-oxo-ethyl thiophene amide compound is isofetamid.

6. The liquid fungicidal composition of claim 1, wherein the relative weight ratio of the at least one DMI fungicide to the at least one SDHI fungicide is from about 0.5:1 to about 10:1.

7. The liquid fungicidal composition of claim 1, wherein the at least one DMI fungicide and the at least one SDHI fungicide are dispersed in an aqueous carrier.

8. The liquid fungicidal composition of claim 1, wherein the liquid fungicidal composition further comprises one or more surfactants.

9. The liquid fungicidal composition of claim 1, wherein the liquid fungicidal composition is a liquid fungicidal formulation.

10. A method of reducing the incidence of fungal infestations in vegetation comprising the step of applying, in the locus of the vegetation, a fungicidal composition comprising at least one demethylation inhibitor (DMI) fungicide and at least one succinate dehydrogenase inhibiting (SDHI) fungicide.

11. The method of claim 10, wherein the at least one DMI fungicide comprises a triazole compound.

12. The method of claim 11, wherein the triazole compound is tebuconazole.

13. The method of claim 10, wherein the at least one SDHI fungicide comprises a phenyl-oxo-ethyl thiophene amide compound.

14. The method of claim 13, wherein the phenyl-oxo-ethyl thiophene amide compound is isofetamid.

15. The method of claim 10, wherein the relative weight ratio of the DMI fungicide to the SDHI fungicide is from about 0.5:1 to about 10:1.

16. The method of claim 10, wherein the fungicidal composition is provided as a premix formulation that is diluted prior to application.

17. A method of reducing the phytotoxic effects of demethylation inhibitor (DMI) fungicide applications on vegetation comprising the step of applying, in the locus of the vegetation, a fungicidal composition comprising at least one DMI fungicide and at least one succinate dehydrogenase inhibiting (SDHI) fungicide.

18. The method of claim 17, wherein the fungicidal composition is a liquid fungicidal composition.

19. A method of reducing the phytotoxic effects of repeated fungicide applications of demethylation inhibitor(s) (DMI(s)) on vegetation comprising the step of repeatedly applying, in the locus of the vegetation, a fungicidal formulation comprising at least one DMI fungicide and at least one succinate dehydrogenase inhibiting (SDHI) fungicide.

20. The method of claim 19, wherein the fungicidal formulation is a liquid fungicidal formulation.

21. A method of treating vegetation with a liquid fungicidal formulation comprising the step of applying, in the locus of the vegetation, the liquid fungicidal formulation, the liquid fungicidal formulation comprising at least one DMI fungicide and at least one succinate dehydrogenase inhibiting (SDHI) fungicide.
